(19) United States
(12) Patent Application Publication
(10) Pub. No.: US 2008/0254325 A1
(43) Pub. Date: Oct. 16, 2008

(54) System for transferring metal to electronic energy

(76) Inventor: Yu Zhou, Dublin, CA (US)

Correspondence Address: MORRISON & FOERSTER LLP, 755 PAGE MILL RD, PALO ALTO, CA, 94304-1018, US

(21) Appl. No.: 12/079,556

(22) Filed: Mar. 26, 2008

Related U.S. Application Data
(63) Continuation of application No. 10/286,328, filed on Nov. 1, 2002, now abandoned.

(51) Int. Cl. H01M 8/04; H01M 8/18

(52) U.S. Cl. 429/17; 429/19

(57) ABSTRACT

Disclosed are a device and method for generating electrical energy. The device has a fuel cell that converts hydrogen gas to electricity; and a fuel cartridge in fluid communication with the fuel cell and containing a fuel which reacts with water to form the hydrogen gas. The fuel comprises a solid metal or alloy, and the fuel cartridge is configured such that the rate of hydrogen gas generation decreases automatically without consuming electricity as demand for the hydrogen gas decreases.

### CROSS-REFERENCE TO RELATED APPLICATIONS

This application is a continuation of U.S. Ser. No. 10/286,328, filed Nov. 1, 2002, the entire contents of which are incorporated by reference herein as if put forth in full below. The text of the aforementioned application is appended prior to the claims as “Appendix I” as are its original claims, which have been reworded in paragraph form.

### BACKGROUND OF THE INVENTION

This invention relates generally to the field of generating electrical energy, and more particularly to a system and method for utilizing a metal to help generate electrical energy.

The use of a hydrogen/oxygen (air) fuel cell as a zero-emission, environmental friendly power source has been of increasing interest since the fuel cell was invented about 150 years ago. However, even now one cannot tell exactly how long successful commercialization of a fuel cell will take, since several crucial technologies need to be successfully developed. The suitable and convenient storage and delivery of hydrogen is one of the biggest barriers to successful commercialization of the fuel cell. Obviously, existing technologies for hydrogen storage and delivery do not meet the requirements for deploying fuel cells commercially.

The successful implementation of a hydrogen storage, delivery and production system will be crucial to commercializing the fuel cell. The obvious deficiencies of existing technologies for hydrogen storage and delivery, alternative fuel cells and alternative fuel technologies must be addressed. Alternative fuel technologies include reforming methanol and gasoline, high or super-high pressure storage technology and solid hydrogen storage. Alternative fuel cells include direct methanol fuel cells, direct metal air fuel cells and direct borohydride fuel cells. However, all these alternatives still require substantial development prior to successful commercialization.

This invention combines a hydrogen-oxygen (air) fuel cell and hydrogen generator together into a single system. By using the mature technologies existing in hydrogen/oxygen fuel cell and generating hydrogen continuously for instance from the attached hydrogen generator, this invention provides a novel way to make a fuel cell.

In mobile computing, the equipment is only as good as the power supply that runs it. While processors increase in speed, network bandwidth increases, and software applications get “smarter,” the power needs increase, and the power supply that runs the processor, network communications, and applications limits operating time. The best mobile power supplies may include batteries such as Li batteries and alkali batteries, rechargeable batteries such as Pb-Acid, Ni-MH and Li-ion rechargeable batteries; fuel cells such as hydrogen-oxygen fuel cells and solid oxide fuel cells; and alternative fuel cells such as direct methanol fuel cells, direct metal air fuel cells and direct sodium borohydride fuel cells.

However, traditional batteries even including the most powerful batteries such as Li batteries and alkali batteries cannot provide a continuous power supply. Once the materials inside these batteries are reacted or spent, the batteries are dead. Rechargeable batteries such as Ni/Cd, Ni/MH Pb/acid and Li-ion batteries can be recharged several hundreds times, but their capacities are limited. For example even the most powerful Li-ion rechargeable battery can only run a laptop for about 3 hours. As the number of charge-discharge cycles increases, most people find that battery capacity gradually decreases until the battery is useless, and this can occur within about one year.

A traditional fuel cell, especially polymer electrolyte fuel cell (PEM Fuel Cell), is a promising power source for mobile computing because it can run for several thousands or more hours even at ambient temperature. However, a fuel cell requires hydrogen as a fuel and therefore, an extra hydrogen tank or an accessory hydrogen storage-delivery system is needed to power a fuel cell. As noted above, hydrogen supply is the biggest barrier to a fuel cell's successful commercialization. An extra hydrogen tank or storage system is inconvenient, expensive and/or dangerous, since hydrogen is a flammable gas. Quite a bit of attention is required to safely implement a stationary application, let alone a portable supply for personal use.

Many hydrogen storage and generation technologies have been developed, such as a hydrogen storage system, hydrogen reforming system, water electrolysis system, sodium water system, sodium borohydride water system, high pressure or super high pressure tanker storage system and even wood steam system. But even today these system are not suitable for fuel cells because of their limitations such as limited capacity, heavy, complex, safety problem, requirement of extra electronic energy or high cost and reliability.

For example U.S. Pat. No. 5,634,341 discloses a system and apparatus using Al and Li metal to react with water to produce hydrogen for a fuel cell or a Rankine cycle engine. In this process, Al and Li metals melt together and then a kind of nozzle is used to control the amount of fuel, by which to control the yielding rate of hydrogen. This technology has two deficiencies: one is that controlling the nozzle is complex and consumes extra electricity, which makes it very difficult to provide a portable and inexpensive application. The second deficiency is this system needs high-pressure hydrogen storage devices, which classifies this system as a traditional high-pressure storage system for hydrogen. Mechanical operation of the nozzle without real-time feedback is difficult, and in operation it is difficult to get the exact amount of fuel within 1 g of accuracy in the disclosed system. 10 grams too much of Al in this system provides 12.4 liters of excess hydrogen. Therefore, it is necessary to provide high-pressure storage for hydrogen generated in the disclosed device.

Sodium was also reported to generate hydrogen for a fuel cell by reacting the sodium with water. However, sodium must be covered with a protective layer on its surface to prevent water from reacting with it when no hydrogen is needed. A device with knifes was then used to cut the protective layer off to let sodium react with water to produce hydrogen. This technology has the same deficiencies as those in U.S. Pat. No. 5,634,341.

U.S. Pat. No. 6,440,385 B1 discloses another method to produce hydrogen using water and Al composite materials. Al can react with water to produce hydrogen using a solution of pH<1 or a solution of pH>11. The patent describes mixing Al and cement into composite to product hydrogen at the proper temperature only from water. Although, this patent provides a chemical process to produce hydrogen from metal Al, the problem of how to apply this reaction to a fuel cell and electricity generating system remains unsolved. An ideal process and apparatus for hydrogen storage and delivery is like a battery with unlimited lifetime. A commercially acceptable hydrogen storage system for portable electronics should also be inexpensive, safe, convenient, compact and portable, and it should provide hydrogen when needed and stop or be dormant when hydrogen is unnecessary.

Alternative fuel cells such as a direct methanol fuel cell, direct metal air fuel cell and even direct borohydride fuel cell use liquid or solid fuels. As there are no problem of hydrogen storage and delivery, these fuel cells are always promising power supplies for mobile computing. These fuel cells directly split fuels into ions or protons and then transfer them through a membrane in the form of H₃O+ or another ion complex to produce electricity. Since the transferring pattern of ion and proton is the same as in a traditional hydrogen-oxygen fuel cell, many unsolved and unique technology problems such as crossover, low potential, low efficiency, short life time and low reliability indicate that these fuel cells are a long way from their successful commercialization.

Therefore, a power supply device and method that is intermediate a traditional hydrogen-oxygen fuel cell and an alternative fuel cell will be promising for mobile computing. This type of technology will not necessarily require extra hydrogen storage and a delivery system as needed by traditional fuel cells, and the device and method can avoid splitting liquid or solid fuels directly into ions or protons as needed in alternative fuel cells.

### SUMMARY OF THE INVENTION

Disclosed are a device and method for generating electrical energy. The device has a fuel cell that converts hydrogen gas to electricity; and a fuel cartridge in fluid communication with the fuel cell and containing a fuel which reacts with water to form the hydrogen gas. The fuel comprises a solid metal or alloy, and the fuel cartridge is configured such that the rate of hydrogen gas generation decreases automatically without consuming electricity as demand for the hydrogen gas decreases.

Also disclosed is a method for generating electricity. The method involves generating hydrogen gas using a solid metal or alloy, converting the hydrogen gas to electricity in a fuel cell, and decreasing the rate of hydrogen gas generation without consuming electricity as demand for hydrogen gas decreases in the fuel cell.

The disclosed apparatuses and methods may or may not provide one or more of the following “objects” or objectives, while of course, the invention is defined in full by the appended claims.

It is desirable to provide a process and apparatus for inexpensively, continuously, reliably and automatically transferring energy stored in a metal to electronic energy.

Another object of the invention is to provide a portable and reliable electronic energy generator for a device that requires a portable or moveable power supply.

Another object of the invention is to provide an inexpensive, portable and reliable power generator to replace traditional batteries, direct metal-air fuel cells, direct methanol fuel cells, and fuel cells that require accessory hydrogen storage devices.

A further object of the invention is to provide an apparatus and process that combines a hydrogen generator and a fuel cell or hydrogen-consuming engine together to produce portable electronic power.

Yet another object of the invention is to provide an alternative way to utilize metal to store electrical energy which avoids many of the problems or barriers present in alternative fuel cells. These barriers include crossover and low potential in a direct methanol fuel cell; low life time, low efficiency and low reliability in a direct metal fuel cell; and the requirement for an accessory hydrogen delivery and storage system in a traditional fuel cell.

Still yet another object of the invention is to provide an apparatus or system for automatically and continuously producing hydrogen from a metal and water with real-time feedback.

Another object of the invention is to provide a method or process for hydrogen generation from metal without acid or alkali solution.

Another object of the invention is to provide a system or apparatus for producing hydrogen by automatically controlling pressure and rate of its generation without consuming electricity to control the pressure and rate of generation.

A further object of the invention is to provide an inexpensive method to produce hydrogen that utilizes a self-regulating process.

Yet another object of the invention is to provide a system or apparatus for producing hydrogen for a fuel cell or other device that consumes hydrogen.

### DESCRIPTION OF THE FIGURES

Other objects and advantages of the present invention will become apparent from the following description, taken in connection with the accompanying drawings, wherein, by way of illustration and example, an embodiment of the present invention is disclosed.

FIG. 1 illustrates an apparatus implementing a process of this invention.

FIG. 2 depicts an outlet structure 62 which provides hydrogen with a rotational plus zig-zag flow pattern through the structure.

FIG. 3 represents a structure inside the apparatus of FIG. 1 that connects chambers. This structure has an internal design and function similar to the device illustrated in FIG. 2.

FIG. 4 depicts a one-way pressure valve located on the top of the structure illustrated in FIG. 3.

The drawings constitute a part of this specification and include exemplary embodiments of the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Electronic energy may be generated by a PEM fuel cell that can be designed to provide the output required by various electronic devices. Today's PEM fuel cells can easily reach a current density of 500-600 mA/cm² at 0.7V even by using dry hydrogen and oxygen. An average hydrogen flow of 1 ml/second can support a current of 8.6 A theoretically, which is twice the current required by a laptop computer. A fuel cell supplied by hydrogen using an apparatus as discussed herein can therefore power a laptop computer or other electronic device.

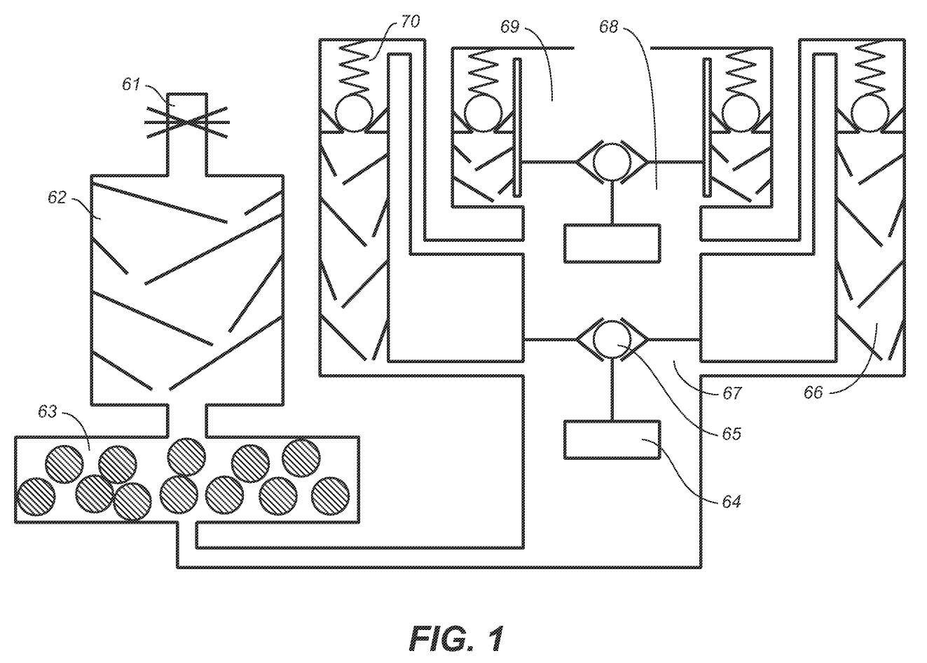

FIG. 1 depicts a hydrogen generating system in accordance with various principles underlying the invention. Explaining first an outlet portion of the depicted hydrogen generating system for reasons that will become apparent below, hydrogen flows from valve 61 into a fuel cell (not shown for purposes of clarity) to produce electronic energy (electricity). Outlet structure 62 is configured internally with baffles as depicted which direct hydrogen to flow in a zig-zag plus spiral pattern through outlet structure 62 to valve 61. During its zig-zag plus rotational flow, alkaline water carried by the hydrogen gas will be separated from the gas.

Inside cartridge 63 is solid material formed of metallic Al and KOH or NaOH. These materials have two functions—forming alkaline solution and splitting water to hydrogen. Of course, the cartridge may contain any metals or alloys that can react with water or other liquids to produce hydrogen, or any materials that can form alkaline or acidic solution with water or another liquid. The nature of solid and liquid surface area in contact with one another can be one major factor in controlling chemical reaction rate. It may therefore be helpful to form different shapes, structures, and compositions of materials in the cartridge to obtain the desired reaction rate. The factors in selecting shape, structure, and composition are well-known in modern materials science and engineering.

Valve 65 connects chambers 67 and 68, and a similar valve depicted above it connects chambers 68 and 69. Buoyant piece 64 connected to valve 65 automatically controls opening and closing of valve 65 through its buoyant force and weight. Buoyant piece 64 also controls the water level in cartridge 63. The water level in cartridge 63 (represented as “h” in FIG. 1) is a very important parameter that controls the rate of hydrogen generation. The higher the water level in cartridge 63 is, the larger the connected surface area between metallic Al and water will be and, therefore, the higher the reaction rate of hydrogen generation from cartridge 63 is.

Chambers 67, 68 and 69 are positioned at different levels. Chambers 67 and 68 connect to each other by valve 65, gas separation device 66 and valve 70, and likewise chambers 68 and 69 connect to each other through a valve, gas separation device, and valve. Gas separation device 66 has a similar baffle structure internally as outlet structure 62, by which makes fluid (including water and air) flow to valve 70 in a rotating plus zig-zag pattern cushioned by the baffles. Meanwhile, by giving device 66 enough volume to reserve water and reserving air in the top of device 66 through the closing of valve 70, alkali and water will be mainly or completely kept in 66 but not to go to chamber 68 and 69. Therefore, the concentration of alkali solution in chamber 68 is far less than in chamber 67. And in chamber 69 there is almost no alkali solution due to similar operation of its valve and gas separation device. Inside the top chamber 69 is almost neutral water. The problem of sealing alkali or acid solution that exists in industries such as the battery industry and chemical industry is easily solved here by this system which essentially isolates the aqueous KOH solution in chamber 67 with chamber 68, containing aqueous KOH of lower concentration, and chamber 69 which contains almost pure water.

Valve 70 is a one-way valve that can be opened at a given pressure. Valve 70 maintains the pressure in the cartridge 63 and chambers 67 within a safe range. A valve likewise maintains the pressure in chamber 68 within a safe range. Valve 70 also controls the pressure of yielded hydrogen and stops water from flowing back into the lower chamber 67 when valve 65 is closed. Valves 65 and 70 are normally closed during production of hydrogen and electricity.

The system may be operated as follows. First one pours water into empty chamber 69. Water flows to empty chamber 68, then to empty chamber 67 and finally reaches cartridge 63. Once the water in cartridge 63 reaches a given level to make the buoyant piece 64 float, valve 65 will automatically close and chambers 67, 68 and 69 are disconnected from one another. Inside cartridge 63, solid KOH will dissolve to become alkaline solution. Or, one may just add some acid or alkali solution into cartridge 63 to form a solution with pH<4 or pH>9. Then e.g. metallic Al in cartridge 63 will react with water to produce hydrogen according to the following reaction:

2Al+6H₂O→2Al(OH)₃+3H₂↑

The yielded hydrogen rises through outlet structure 62 to separate alkaline solution from the gas, which then travels to a fuel cell. The fuel cell consumes this hydrogen to produce electronic energy by the following reaction

2H₂+O₂(air)→H₂O+electronic energy

According to the above reaction, 100 grams Al plus 200 grams water produces 124 liters of hydrogen, which is equivalent to about 340 Ah capacity of electronic energy. For example, a 4 Ah capacity of battery runs a laptop for about 2 hours, and therefore a 340 Ah capacity of electronic energy produced from 100 gram Al will run a laptop for about 172 hours theoretically, which is equal to 7 full days of operation without recharging.

Considering 1 L/min flow of hydrogen can support about 143.6 A of current, 1 ml/second of hydrogen will support 8.6 A of current, which is twice the current required by a laptop. Such a low rate of hydrogen release is not only easy to be carried out from 100 gram granular Al without any extra treatment, but also makes it easy to keep the whole apparatus small enough for a portable or personal application. Of course, an extra treatment to increase surface area of Al granules may be needed for other applications.

With the fuel cell continuously producing electronic energy, hydrogen will be continuously consumed and water in cartridge 63 and chamber 67 will of course be continuously consumed. Once water in cartridge 63 and chamber 67 is consumed to a low level, buoyant piece 64 will have not enough buoyant force to close valve 65. Valve 65 will therefore automatically open to supply more water from the upper chambers. As these processes repeat, the water in cartridge 63 and chamber 67 always maintains the same level. Electronic energy or hydrogen will be continuously produced until the metallic Al in cartridge 63 is used, and then a new cartridge is inserted in place of cartridge 63.

When the fuel cell requires less hydrogen or no hydrogen or if the rate of hydrogen generation is greater than the rate at which the fuel cell consumes it, pressure in cartridge 63 will increase. The increased pressure will force the water in cartridge 63 back to chamber 67, or even through 66 and valve 70 to chamber 68 or 69. As the water is forced back to other chambers, less or no Al will connect the water, and therefore less or no hydrogen will be produced. By this process, the rate of hydrogen generation will be automatically controlled or fed-back in real time in response to the hydrogen demand of the attached fuel cell. This process also keeps pressure of hydrogen in cartridge and fuel cell constant.

The volume and inner structure of gas separation device 66 are very important. The volume must be large enough to hold the water forced back from cartridge 63 and also to keep some space on the top for an air cushion, which has the function of limiting alkali leaking into the preceding chamber.

As an example of calculating the desired volume for gas separation device 66, it is assumed a laptop is required to run for about 2 days, and therefore 50 grams Al and 100 grams water are necessary. The rate of generating hydrogen is assumed to be 1 ml/second in this design, and it is assumed that hydrogen stops being produced 1 minute after the water and Al no longer contact one another. A total volume of 200 ml for chamber 67 and device 66 together will be sufficiently large for this application. This volume can be further minimized considering that water pours in at several different times. As noted previously, within gas separation device 66 is a baffle structure that forces water and air to travel in a zig-zag, rotating pattern and through valve 70 to upper chambers, which helps alkali separate from air. This way the upper chambers have a lower concentration of alkali or acid than the lower chambers.

For a device using alkaline or acidic solution to produce hydrogen or other gases, one of the big problems is leakage of alkaline or acidic solution outside the device. This problem even exists in the alkaline battery industry. As mentioned above, this invention comprises a multi level chambers 67, 68 and 69 that can be automatically connected or disconnected to or from each other as a result of real-time feedback according to the rate of hydrogen consumed by a fuel cell. During this feedback process, fresh water can go freely from the upper chamber to the lower chamber and at the same time alkaline or acidic solution will be prevented from traveling to the upper chamber. This way, the top chamber 69 has almost no alkaline or acidic solution, which make this device easy to seal and the device suitable for portable or personal applications.

Safety is of course an important consideration when applying this invention to portable or personal applications. As hydrogen is the lightest gas and is the smallest atom, its diffusion or dilution rate in air is far higher that 1 ml/second that is the rate of generating hydrogen to support about 8.6 A of current as mentioned above. Considering a laptop only needs a 4-5A of maximum current, therefore, such a device designed for a laptop should not have safety problems unless the laptop is used in a very small and defined space without airflow. Of course such a device can not properly be used in a small and defined space where there is lower oxygen or no oxygen at all because the attached fuel cell needs oxygen.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### APPENDIX I

### Background of the Invention

This invention relates generally to the field of electronic energy generator, and more particularly to system for transferring metal to electronic energy.

The use of hydrogen/oxygen (air) fuel cell as zero-emission, environmental friendly power sources has been of increasing interest since fuel cell was invented about 150 years ago. However, even by now we cannot tell exactly how far away a fuel cell is from its successful commercialization before several crucial technologies being successfully developed. Suitable and convenient storage and delivery system of hydrogen is one of the biggest barriers against successful commercialization of fuel cell. Obviously, existing technologies of hydrogen storage and delivery don't match fuel cell's requirement at all.

Realizing hydrogen storage, delivery and producing system will take a crucial role in commercialization of fuel cell and obvious deficiencies of existing technologies for hydrogen storage and delivery, alternative fuel cells and alternative technologies of fuel are being developed. Alternative technologies of fuel include reforming methanol and gasoline, high or super-high pressure storage technology and solid hydrogen storage etc. alternative fuel cell include direct methanol fuel cell, direct metal air fuel cell and direct borohydride fuel cell etc. However, all these alternatives still have a long way to reach their goal.

This invention combines hydrogen-oxygen (air) fuel cell and hydrogen generator together. By using the mature technologies existing in hydrogen/oxygen fuel cell and getting in-suit hydrogen continuously, reliably and smartly from the attached hydrogen generator, this invention provides a novel way to make fuel cell successful.

Everyone knows that in mobile computing, the equipment is only as good as the power supply that runs it. While processors get faster, networks get wider and applications get smarter, the power supply that runs all these continue to lag. The best supplies for mobile computing according to today's standards includes batteries such as Li batteries and alkali batteries etc. rechargeable batteries such as Pb-Acid, Ni-MH and Li-ion etc rechargeable batteries, fuel cells such as hydrogen-oxygen fuel cell and solid oxide fuel cell etc; Alternative fuel cells such as direct methanol fuel cell, direct metal air fuel cell and direct sodium borohydride fuel cell etc.

However, traditional batteries even including the most powerful batteries such as Li batteries and alkali batteries cannot give us a continuous power supply. Once the materials inside these batteries are reacted or used out, they are dead. Rechargeable batteries such as Ni/Cd, Ni/MH, Pb/acid and Li-ion batteries can be 1 S recharged several hundreds times, but their capacities are limited. For example, even the most powerful Li-ion rechargeable battery can only run a laptop for about 3 hours and with the increasing of charge-discharge cycles, most people will find the capacity will gradually decreased till finally useless within about one year. Traditional fuel cell, especially polymer electrolyte fuel cell (PEM fuel cell) is a promising power source for mobile computing because it can run for several thousands or more hours even at ambient temperature. However, it needs hydrogen as fuel and therefore, an extra hydrogen tanker or accessory hydrogen storage-delivery system is needed, which is becoming the biggest barrier against this kind of fuel cell's successful commercialization. An extra hydrogen tanker or storage system is always inconvenient, expensive or dangerous for a flammable gas. A stationary application is even asked to take attention, let alone portable and personal applications. In order to remove this barrier, many efforts and technologies such as hydrogen storage system, hydrogen reform system, water electrolysis system, sodium water system, sodium borohydride water system, high pressure or super high pressure tanker storage system and even wood steam system etc have been made. But even by today we cannot say these systems are suitable for fuel cells because of their limitations such as limited capacity, heavy, complex, safety problem, requirement of extra electronic energy or high cost and reliability etc. For example, U.S. Pat. No. 5,634,341 disclosed a system and apparatus using Al and Li metal to react with water to produce hydrogen for fuel cell or Ranike cycle engine. In this process, Al and Li metals are required to melt together first and then a kind of nuzzle is used to control the amount of fuel, by which to control the yielding rate of hydrogen. It has two deficiencies: one is the controlling of nuzzle is complex and consumes extra electronic energy, which makes it very difficult to become a portable and inexpensive application. The second deficiency is this system needs high-pressure hydrogen storage devices, which classifies this invention to traditional high-pressure storage of hydrogen. Everyone knows 1 g Al produces 1.241 hydrogen gas and mechanical operation of nuzzle without real-time feedback is difficult to get exact amount of fuel within 1 g of accuracy. 10 grams of error will get 12.4 liters hydrogen. Therefore, no need high-pressure devices to store these hydrogen is impossible. Sodium was also reported to generate hydrogen for fuel cell by reacting with water. However, said sodium must be covered a protection layer on its surface to stop water reacting with it when no hydrogen was needed. A device with knifes was then needed to cut this protection layer off and let sodium react with water to produce hydrogen. This technology faces the same deficiency as in U.S. Pat. No. 5,634,341. U.S. Pat. No. 6,440,385B1 disclosed another method to produce hydrogen by neutral water and Al composite materials. Everyone knows Al can react with water to produce hydrogen at solution of pH<1 and pH>11. the biggest patentability of this technology is mixing Al and cement into composite and then yielding hydrogen at proper temperature only from neutral water. Although, this patent provides a novel chemical process to produce hydrogen from metal Al, but how to apply this reaction to fuel cell and energy generating system remains unsolved. In fact, a process and apparatus for hydrogen storage and delivery we really need is like a battery without lifetime limited. Beside inexpensive, safe, convenient, compact and portable, it works when needs it to work and stop or is dormant when doesn't.

Alternative fuel cells such as direct methanol fuel cell, direct metal air fuel cell and even direct borohydride fuel cell etc use liquid or solid fuels. As there are no problem of hydrogen storage and delivery, these fuel cells are always promising power supplies for mobile computing. All these fuel cells are developed by the concept of directly splitting fuels into ions or protons and then transferring them through membrane at the form of H₃O⁺ or other ion complex to produce electronic energy. As the transferring pattern of ion and proton is the same as they are made in traditional hydrogen-oxygen fuel cell, many unsolved and unique technology problems such as crossover, low potential, low efficiency, short life time and low reliability etc give these fuel cells a long way before their successful commercialization.

Therefore, a process and apparatus that is between traditional hydrogen-oxygen fuel cells and alternative fuel cells will be a promising power supply for mobile computing. This will be a novel method that is no need extra hydrogen storage and delivery system as required by traditional fuel cells and avoids splitting liquid or solid fuels directly into ions or protons as used in alternative fuel cells. That's the invention.

### SUMMARY OF THE INVENTION

The primary object of the invention is to provide a process and apparatus for inexpensively, continuously, smartly, reliably and automatically transferring metal to electronic energy.

Another object of the invention is to provide a portable and reliable electronic energy generator for any device that needs portable or moveable power supply.

Another object of the invention is to provide an inexpensive, portable and reliable power plant to replace traditional batteries, direct metal air fuel cells, direct methanol fuel cell and fuel cells that need accessory hydrogen storage devices.

IS A further object of the invention is to provide an apparatus and process that simply combines hydrogen generator and fuel cell or hydrogen-consuming engine together to produce portable electronic power.

Yet another object of the invention is to provide an alternative pattern to transfer metal to electronic energy by avoiding many barriers of technology existed in alternative fuel cell. These barriers of technology include crossover and low potential in direct methanol fuel cell, low life time, low efficiency and low reliability in direct metal fuel cell, requirement of extra or accessory hydrogen delivery and storage system in traditional fuel cell.

Still yet another object of the invention is to provide an apparatus or system for automatically continuously yielding hydrogen with real-time feedback from metal and water.

Another object of the invention is to provide a method or process for hydrogen generating from metal without leaking of acid or alkali solution or provide a novel method to stop alkali or acid solution leaking in reaction of liquid with solid.

Another object of the invention is to provide a system or apparatus for yielding hydrogen by automatically controlling its pressure and rate without consuming electronic energy.

A further object of the invention is to provide an inexpensive method for produce hydrogen with automatically controlled process.

Yet another object of the invention is to provide a system or apparatus of producing hydrogen for fuel cell or other devices that consumes hydrogen.

Other objects and advantages of the present invention will become apparent from the following descriptions, taken in connection with the accompanying drawings, wherein, by way of illustration and example, an embodiment of the present; invention is disclosed.

FIG. 1 represents the whole process of this invention

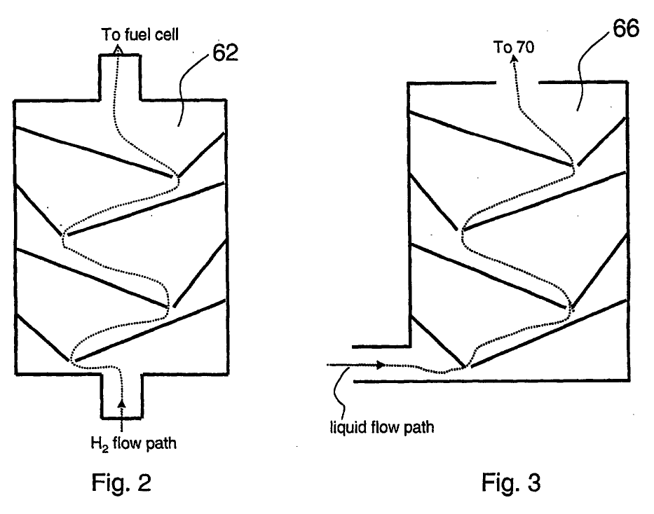

FIG. 2 represents outlet of hydrogen with structure of making hydrogen flow at rotational plus zag-zig pattern. It has similar structure and function as device showed in FIG. 3.

FIG. 3 represents inside structure of device that connects chambers. It has similar inside structure and function as device showed in FIG. 2.

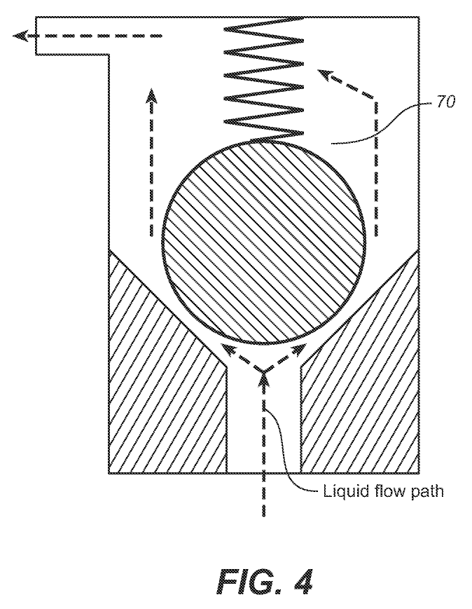

FIG. 4 represents the one-way pressure valve located on the top of device showed in FIG. 3.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the present invention, FIG. 1 shows the whole ideas of this invention. First lets introduce structures of some devices in this invention. Electronic energy will be generated by PEM fuel cell that can be differently designed according to the output required by electronic devices. Today's PEM fuel cell can easily reach a current density of 500-600 mA/cm² at 0.7 V even by using dry hydrogen and oxygen. An average hydrogen flow of 1 ml/second can support a current of 8.6 A theoretically, which is twice of the current requited by a laptop computer. According to these parameters, an attached fuel cell with required output and its correspondent hydrogen yielding reaction will be easy to design. The attached fuel cell is hidden in this figure. Device 61 represents a valve, from which the hydrogen yielded in this invention flows into fuel cell to produce electronic energy. Structure 62 is outlet of hydrogen that has an inside structure for making hydrogen flow at a zag-zig plus rotational pattern to valve 61. During its zag-zig plus rotationally flow, alkali water containing in hydrogen will be separated. Inside cartridge 63 are solid materials of metal Al, KOH or NaOH. These materials have two functions—forming alkali solution and splitting water to hydrogen. Of course, inside cartridge also may be any metals or alloys that can react with water or other liquids to produce hydrogen, or any materials that can form alkali or acid solution with water or other liquids. As connected surface area between solid and liquid is one of the main factors to control chemical reaction rate, these materials in cartridge may need to be treated as different shapes, structures and compositions for obtaining required reaction rate.

Modern materials science and engineering technology made these treatments mature and inexpensive. Valve 65 connects chamber 67, 68 and 69. Buoyant 64 automatically controls valve 65's opening and closing through its buoyant force and weight. Buoyant 64 also controls the water level in cartridge 63 The water level (be represented as “h” in FIG. 1) in cartridge is a very important parameter to control the rate of hydrogen yielding. The higher the water level in cartridge 63 is, the larger the connected surface area between metal Al and water will be and finally, the higher the reaction rate of hydrogen yielding from cartridge 63 is. Device 67, 68 and 69 are three chambers located in different levels. They connect each other by valve 6S, device 66 and valve 70. Device 66 has almost the same inside structure as device 62, by which makes fluid (including water and air) flow to valve 70 at a rotational plus zag-zig and cushion pattern. Meanwhile, by giving device 66 enough volume to reserve water and reserving air in the top of device 66 through the closing of valve 70, alkali and water will be mainly or completely kept in 66 but not to go to chamber 68 and 69. Therefore, the concentration of alkali solution in chamber 68 is far less than in chamber 67. And in chamber 69 there is almost no alkali solution. As inside the top chamber 69 is almost neutral water, the problem of sealing alkali or acid solution existing in industries such as in batteries industry and chemical industry etc will be easily solved here. Valve 70 is a one-way valve that can be opened at a given pressure. It keeps the pressure in cartridge and chambers in safety. Valve 70 also has the function to control the pressure of yielded hydrogen and stop water flowing back to the lower chambers. Valve 65 and 70 are normally closed during producing of electronic energy and hydrogen.

Followings are the operation steps, processes and functions comprised in this invention or how this invention works. First pouring water into chamber 69. Water flows to the chamber 68, then to 67 and finally reaches to cartridge 63. Once the water in cartridge 63 reaches a given level to make buoyant 64 float, valve 65 will be automatically closed and chamber 67, 68 and 69 are disconnected. Inside cartridge, solid KOH will dissolve to become alkali solution. Or just adding some extra acid or alkali solution into cartridge to form a solution with pH<4 or pH>9. then metal Al etc in cartridge will react with water to produce hydrogen according to the following reactions:

2Al+6H₂O→2Al(OH)₃+3H₂↑

The yielded hydrogen goes up through device 62 to separate alkali solution and then to fuel cell. Fuel cell will consume this hydrogen to produce electronic energy by the following reaction:

2H₂+O₂(air)→H₂O+electronic energy

According to above reaction, 100 gram Al plus 200 gram water produces 124 liters hydrogen, which is equal to about 340 Ah capacity of electronic energy. For example, a 4Ah capacity of battery runs a laptop for 2 hours, 340 Ah capacity of electronic energy produced from 100 gram Al will run a laptop for about 172 hours theoretically, which is equal to 7 whole days.

Considering 1 L/min flow of hydrogen can support about 143.6 A of current, 1 ml/second of yielding rate of hydrogen will support 8.6 A of current, which is twice the current required by a laptop. Such a low rate of hydrogen yielding is not only easy to be carried out for a 100 gram granular Al without any extra treatment, but also makes it easy to keep the whole apparatus small enough for a portable or personal application. Of course, an extra treatment for increasing surface area of Al granular may be needed for other applications.

With fuel cell continuously producing electronic energy, hydrogen will be continuously consumed and water in cartridge 63 and chamber 67 will of course to i be continuously consumed. Once water in cartridge 63 and chamber 67 is consumed to a low level, buoyant 64 will have not enough buoyant force to close valve 65. And then valve 65 will automatically open to supply more water from the upper chambers. As these processes above keep repeating, the water in cartridge and chamber 67 always keeps the same level. Electronic energy or hydrogen will be continuously produced until the metal Al in cartridge is used out and then a new cartridge is changed.

When fuel cell needs less or no need hydrogen any more or the yielding rate of hydrogen is larger than consuming rate by fuel cell, pressure in cartridge 63 will increase. The increased pressure will force the water in cartridge 63 back to chamber 67, or even through 66 and valve 70 to chamber 68 or 69. As the water is forced back to chamber, less or no Al will connect with water and less or no hydrogen will be produced any more. By this process, the yielding rate of hydrogen will be automatically controlled or real-time feedbacked by the requirement of the attached fuel cell. This process also keeps pressure of hydrogen in cartridge and fuel cell constant.

Device 66's volume and inner structure are very important. Its volume must be larger enough to reserve the water forced back from cartridge and also need to keep some space on the top for air cushion, which has function to limit alkali leaking. For example, if applying this invention to a laptop that is required to run for about 2 days, 50 grams Al and 100 grams water are necessary. Designing the yielding rate of hydrogen as 1 ml/second and assuming the hydrogen will stop yielding 1 minute later after the water and Al disconnected. Therefore, a total volume of 200 ml for chamber 67 and device 66 together will larger enough for this application. Considering water always being divided to pour in at several times in fact, this volume can be further minimized. Inside 66 is a structure of making water and air go through valve 70 to upper chambers at a zag-zig plus rotational pattern, which makes alkali contained in the air separated. By this way the upper chambers always have lower concentration of alkali or acid than the lower chambers.

For a device using alkali or acid solution to yield hydrogen or other gases, one of the big problems is the leaking of alkali or acid solution to outside. This problem even exists in alkali battery industry. As mentioned above, this invention comprises a multi levels chamber 67, 68 and 69 that can be automatically connected or disconnected each other at a real-time feedback pattern according to the rate of hydrogen consumed by fuel cell. During this feedback process, fresh water can go freely from the upper chamber to the lower chamber and at the same time alkali or acid solution will be stopped going up to the upper chamber. By this way, inside the top chamber 69 is almost no alkali or acid solution, which makes this device easy to seal and this invention suitable for portable or personal applications.

Once applying this invention to portable or personal applications, safety becomes the most important consideration. As hydrogen is the lightest gas and has the smallest atom in the world, its diffusion or dilution rate in air is far higher than 1 ml/second that is the designed yielding rate of hydrogen to support about 8.6 A of current as mentioned above. Considering a laptop only needs a 4-5 A of maximum current, therefore, unless in a very small and defined space without airflow at all, such a device designed for a laptop application should not have safety problems. Of course such a device can not properly be used in a small and defined space where there is lower oxygen or no oxygen at all because the attached fuel cell needs oxygen.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Examples of what is disclosed are:

1. A kind of process and apparatus for inexpensively, automatically, continuously and smartly transferring metal to hydrogen and then to electronic energy to replace traditional batteries, direct metal-air fuel cell, direct methanol fuel cell and hydrogen-consuming fuel cells that need accessory hydrogen delivery and storage system. Said process and apparatus comprising: A removable cartridge and multilevel chambers.

2. Said removable cartridge in paragraph 1 containing metals or alloys such as but not limited Al, Zn etc that can react with water or other liquids in alkali, acid and neutral solution to produce hydrogen. The alkali or acids solution can be put into said cartridge by any method and any way and any time.

3. Said removable cartridge in paragraph 1 also containing materials such as but not limited metal Na, K etc that can react with water or other liquid to form alkali solutions or materials such as but not limited KOH, NaOH etc that will dissolve water to form alkali solution.

4. Said removable cartridge in paragraph 1 may also containing acid solution-forming materials that can be reacted with said materials in paragraph 2 to produce hydrogen gas.

5. Said removable in paragraph 1 means any, some or the whole parts of cartridge removable, changeable or rechargeable. It also means any, some or whole parts of the said cartridge with any other part of said process and apparatus in paragraph 1 together removable, changeable or rechargeable.

6. Said multilevel chambers in paragraph 1 comprising at least 2 chambers located at different levels. Chamber at lower level connects upper chamber by valves and outlet devices

7. Said valves in paragraph 6 can be automatically opened/closed by weight, spring force or buoyant force. Said buoyant force is real-time controlled by water in chambers

8. Said outlet devices in paragraph 6 have inside structures of making water or gases flow at rotational plus zag-zig pattern.

9. Said structures and rotational plus zag-zig pattern in paragraph 8 have functions of cushioning fluids and separating alkali or acid solution from gases

10. On the top of said outlet devices in paragraph 6 connects pressure-controlled one-way valves, which allow air and water go through from lower chambers to upper chambers only when their pressures are high enough.

11. Said multilevel chambers in paragraph 1, said valves and outlet devices in paragraph 6 have functions of making alkali or acid solutions automatically stay in different chambers with different concentrations. The concentration of alkali or acid will be obviously decreased from the bottom chamber to upper chamber and on the top chamber is almost no alkali or acid solution.

12. Said valves and outlet devices in paragraph 6 have functions of automatically controlling pressure and rate of hydrogen yielding that have a real-time feedback relation to the electronic energy produced by attached fuel cell.

13. Said process and apparatus in paragraph 1 further comprising an outlet of hydrogen. Said outlet of hydrogen comprising the same structure as the said outlet devices in paragraph 6.

14. Said outlet of hydrogen in paragraph 13 has functions of making hydrogen flow at rotational plus zag-zig pattern, cushioning hydrogen and separating alkali, acid solution or even water from hydrogen gas.

15. Said process and apparatus in paragraph 1 further comprising a fuel cell that consumes hydrogen yielded from cartridge to produce electronic energy and current.

16. The yielding rate of said hydrogen in paragraph 15 is real-time controlled by the requirement of fuel cell. The much the fuel cell produces electronic energy, the higher the yielding rate of hydrogen will be. No electronic energy is produced from fuel cell, no hydrogen will be produced from the cartridge.

17. The yielding rate of said hydrogen in paragraph 15 is also real-time controlled by the consuming rate of hydrogen by any hydrogen-consuming devices. Therefore, said apparatus in paragraph 1 is not only an electronic energy generator, but also a hydrogen generator that can match any hydrogen-consuming devices.

18. Said real-time control in paragraph 16 is carried out by pressure, weight, buoyant force, spring force and level of water in cartridge or chambers, no need consuming extra electronic energy that comes from attached fuel cell, other supplies or wherever.

19. Said functions in paragraph 11 of making alkali or acid solutions automatically stay in different chambers with different concentrations makes the top chamber almost no alkali or acid solution, which provides a novel and inexpensive method for sealing or stopping alkali and acid solutions from leaking to outside.

What is claimed is:

1. A device for generating electrical energy comprising:
a fuel cell that converts hydrogen gas to electricity; and
a fuel cartridge in fluid communication with the fuel cell and containing a fuel which reacts with water to form the hydrogen gas, said fuel comprising a solid metal or alloy;
wherein the fuel cartridge is configured such that a rate of the hydrogen gas generation decreases automatically without consuming electronic energy as demand for the hydrogen gas decreases.

2. A device for generating electrical energy according to claim 1:
wherein the cartridge is configured such that hydrogen gas pressure in said cartridge is controlled by the consumption of said hydrogen gas by said fuel cell, and an increase in the hydrogen gas pressure decreases production of said hydrogen gas.

3. A device for generating electrical energy according to claim 2:
wherein said increase in the hydrogen gas pressure decreases the rate of the hydrogen gas generation by displacing the water from said fuel cartridge.

4. A device for generating electrical energy according to claim 3:
further comprising a chamber for collecting the hydrogen gas and separating the water from said hydrogen gas.

5. A device for generating electrical energy according to claim 4:
wherein the chamber contains baffles that separate the water from said hydrogen gas by causing said hydrogen gas to flow in a rotational plus zig-zag pattern.

6. A device for generating electrical energy according to claim 1:
wherein said fuel cartridge is wholly or partially removable, changeable, and/or rechargeable.

7. A device for generating electrical energy according to claim 1:
wherein said metal or alloy comprises Al, Zn, or Mg which can react with acidic, neutral, or alkaline water to form the hydrogen gas.

8. A device for generating electrical energy according to claim 1:
wherein said fuel cartridge further comprises a solid alkali which forms an alkaline solution upon contact with the water.

9. A device for generating electrical energy according to claim 8:
wherein the solid alkali comprises KOH or NaOH.

10. A device for generating electrical energy according to claim 1:
further comprising a plurality of chambers containing the water which reacts with said fuel to produce the hydrogen gas.

11. A device for generating electrical energy according to claim 10:
wherein said plurality of chambers is composed of at least two chambers interconnected by a valve and wherein one of said chambers is disposed between said fuel cartridge and another of said chambers.

12. A device for generating electrical energy according to claim 11:
wherein said chambers are arranged vertically to form a higher level chamber and a lower level chamber with said valve there between to allow the water to flow from the higher level chamber to the lower level chamber as said water flows from said lower level chamber to contact said fuel.

13. A device for generating electrical energy according to claim 12:
wherein said outlet device includes a one way valve connecting the lower level chamber to the adjacent higher level chamber and allowing the water in said chambers to exit the lower level chamber and flow to the adjacent higher level chamber when the hydrogen gas pressure pushes water from the fuel and into the lower level chamber.

14. A device for generating electrical energy according to claim 11:
wherein said plurality of chambers includes a third chamber, said plurality of chambers are connected in series, and the third chamber is separated from its adjacent chamber by a valve.

15. A device for generating electrical energy according to claim 14:
further comprising a one-way valve connecting the third chamber and its adjacent chamber allowing the water in the adjacent chamber to flow into the third chamber when the hydrogen gas pressure pushes water from the fuel and into the lower level chamber.

16. A device for generating electrical energy according to claim 2:
wherein said metal or alloy comprises Al, Zn, or Mg which can react with acidic, neutral, or alkaline water to form the hydrogen gas.

17. A device for generating electrical energy according to claim 16:
wherein said fuel cartridge further comprises a solid alkali which forms an alkaline solution upon contact with the water.

18. A device for generating electrical energy according to claim 17:
wherein the solid alkali comprises KOH or NaOH.

19. A device for generating electrical energy according to claim 7:
wherein said fuel cartridge further comprises a solid alkali which forms an alkaline solution upon contact with the water.

20. A device for generating electrical energy according to claim 19:
wherein the solid alkali comprises KOH or NaOH.

21. A method of generating electricity, comprising generating hydrogen gas using a solid metal or alloy, converting the hydrogen gas to electricity in a fuel cell, and decreasing the rate of generating the hydrogen gas without consuming electrical energy as demand for the hydrogen gas decreases in the fuel cell.
